(19) United States
(12) Patent Application Publication
(10) Pub. No.: US 2009/0055188 A1
(43) Pub. Date: Feb. 26, 2009

(54) PITCH PATTERN GENERATION METHOD AND APPARATUS THEREOF

(75) Inventors: Gou Hirabayashi, Kanagawa (JP); Takehiko Kagoshima, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/035,965

(22) Filed: Feb. 22, 2008

(30) Foreign Application Priority Data
Aug. 21, 2007 (JP) 2007-214407

(51) Int. Cl. G10L 13/08; G10L 13/00

(52) U.S. Cl. 704/260; 704/E13.001; 704/E13.013

(57) ABSTRACT

The prosody control unit pattern generation module generates pitch patterns in respective prosody control units based on language attribute information, the phoneme duration and emphasis degree information, the modification method decision module decides a modification method by smoothing processing with respect to the pitch pattern in a connection portion between the prosody control unit and at least one of previous and next prosody control units based on at least emphasis degree information to generate modification method information, and the pattern connection module modifies pitch patterns generated in respective prosody control units by smoothing processing according to the modification method information and connects them to generate a sentence pitch pattern corresponding to a text to be a target for speech synthesis.

### CROSS-REFERENCE TO RELATED APPLICATIONS

This application is based upon and claims the benefit of priority from the prior Japanese Patent Application No. 2007-214407, filed on Aug. 21, 2007; the entire contents of which are incorporated herein by reference.

### TECHNICAL FIELD

The present invention relates to a pitch pattern generation method and an apparatus thereof in, for example, text-to-speech synthesis, which strongly affects naturalness of synthetic speech.

### BACKGROUND OF THE INVENTION

Recently, a text-to-speech synthesizer which generates speech signals artificially from optional sentences has been developed. Generally, the text-to-speech synthesizer includes three modules of a language processing module, a prosody generation module and a speech signal generation module.

Among them, the performance of the prosody generation module relates to the naturalness of synthetic speech, particularly, the naturalness of a pitch pattern which is a variation pattern of voice tone (pitch) has a great influence on quality of synthetic speech to be generated.

In a conventional pitch pattern generation method in the text-to-speech synthesizer, generation of the pitch pattern was performed by using a relatively simple model, therefore, synthetic speech having unnatural and monotonic intonation is generated.

One of the reasons why speech made by human beings is natural is that there are partial stress variations in speech.

In order to generate synthetic speech in which part of an input text is emphasized, a method of modifying the pitch pattern based on emphasis information has been proposed (for example, refer to Japanese Application Kokai 3-78800). In the method, pitch patterns having partial variations are generated by modifying control parameters such as accent commands controlling the pitch patterns based on emphasis existence or types.

A method of designating degrees of emphasis in emphasized portions has also been proposed (for example, refer to Japanese Application Kokai 5-224689). In the method, physical control parameters such as values multiplying for modifying the pitch pattern are varied according to emphasis levels designated and inputted.

In addition, a method has been proposed, in which, when unit patterns which are pitch patterns cut out in an appropriate unit are connected to generate a pitch pattern including a series of phrases, connection is performed by interpolating between unit patterns (for example, refer to Japanese Application Kokai 6-236197). In the method, the connection is performed by interpolating between unit patterns by linear curve or cubic curve according to the type of the used unit pattern.

In either of these related arts, the pitch pattern is varied for the purpose of obtaining synthetic speech close to natural speech.

However, in the pitch pattern generation method in which pitch patterns are generated in a prosody control unit which is a unit shorter than one sentence, and these pitch patterns are connected to generate a pitch pattern having natural stress variations in the whole sentence corresponding to the input text, there are the following problems in the related arts described above.

A first problem will be considered in a case in which the pitch pattern is largely modified since the designation of emphasis degree in the prosody control unit is strong. In this case, in the related art, linkages at connection parts between the emphasized pitch pattern and adjacent pitch patterns are not smooth, which causes a problem that the naturalness of synthetic speech to be generated will be deteriorate.

For example, assuming that an input text is “Shizenna-gouseionwo-seiseidekimasu” (in English, it means that “Natural synthetic speech can be generated”). The pitch pattern for the input text can be generated by using smoothing processing for reducing discontinuity of patterns at connection boundary portions (hatching portions) as shown in FIG. 3 with respect to pitch patterns generated in the prosody control unit (an accent phrase unit, in this case) as shown in FIG. 2.

Here, generation of synthetic speech in which the degree of emphasis of “shizenna” (meaning that “natural”) which is the second accent phrase is varied will be considered.

In the case of “not emphasized”, the pattern is connected to the following accent phrase smoothly as shown in FIG. 4A by the smoothing processing.

However, in the case that the degree of emphasis for “shizenna” is enlarged, the same smoothing processing as the case of “not emphasized” is applied to the accent phrase pitch pattern modified by the emphasis or to the different accent phrase pitch pattern, a sudden pitch change occurs at the connection portion as shown in FIG. 4B, as a result, generated synthetic speech tends to become unnatural.

As a second problem, in the case that the degree of emphasis for the prosody control unit is not so strong, the smoothing processing to pitch patterns in the connection portions between the adjacent accent phrases is so strong that the pitch change becomes smooth extremely, as a result, the effect of the emphasis for the prosody control unit tends to be inaudible.

In view of the above, an object of the invention is to provide a pitch pattern generation method and an apparatus thereof capable of performing smooth connection at connection portions between the emphasized pitch pattern and adjacent pitch patterns as well as capable of emphasizing the target pitch pattern.

### BRIEF SUMMARY OF THE INVENTION

According to an embodiment of the present invention, the embodiment is a pitch pattern generation method which connects pitch patterns of each prosody control unit in a text to be a target for speech synthesis to generate a pitch pattern corresponding to the text, including a first generating step of generating first pitch pattern reflecting an emphasis degree with respect to respective prosody control unit in the text based on emphasis degree information indicating the emphasis degree in the respective prosody control units and language attribute information in speech to be synthesized, a method deciding step of deciding at least (1) a parameter relating to given smoothing processing or (2) a modification method at a connection portion relating to given smoothing processing, for smoothing connection portions in at least one of previous and next connection portions between the respective first pitch patterns and other first pitch patterns based on the emphasis degree information, and a second generating step of modifying the connection portions of the first pitch patterns based on the modification method to generate a second pitch pattern corresponding to the text.

According to the invention, the modification method by the smoothing processing in the connection portions is decided with respect to pitch patterns of each prosody control unit according to the emphasis degree, and the pitch patterns of each prosody control unit are modified based on the modification method and connected to generate the pitch pattern corresponding to the text to be the target for speech synthesis, therefore, it is possible to generate the pitch pattern having natural variations of the emphasis degree particularly at the connection portions of pitch patterns, as a result, synthetic speech having natural stress variations closer to speech made by human beings can be generated.

### BRIEF DESCRIPTION OF THE DRAWINGS

FIG. 1 is a block diagram showing a configuration of a pitch pattern generation apparatus according to an embodiment of the invention;

FIG. 2 is a chart showing an example of pitch patterns generated for each accent phrase;

FIG. 3 is a chart showing an example of a pitch pattern generated by performing modification due to smoothing processing to pitch patterns of each accent phrase and connecting them;

FIG. 4A and FIG. 4B are charts showing an example of the difference of results of smoothing processing in connection portions with respect to pitch patterns the degree of emphasis of which are different;

FIG. 5 is a flowchart showing an example of processing procedures of a pitch pattern generation apparatus 1;

FIG. 6 is a block diagram showing a configuration example of a prosody control unit pattern generation module;

FIG. 7A and FIG. 7B are charts for explaining methods of control in a smoothing processing section based on the degree of emphasis;

FIG. 8A and FIG. 8B are charts showing examples of pitch patterns of each accent phrase generated by reflecting the degree of emphasis;

FIG. 9A and FIG. 9B are charts for explaining a method of smoothing processing according to smoothing processing sections;

FIG. 10A and FIG. 10B are charts showing an example of the difference of results of smoothing processing of pitch patterns in connection portions with or without control of the smoothing processing section;

FIG. 11A and FIG. 11B are charts for explaining a method of smoothing processing which changes a pitch at the connection point based on the degree of emphasis according to a modification example 3; and

FIG. 12 is a block diagram showing a configuration example of a pitch pattern generation apparatus according to a modification example 6.

### DETAILED DESCRIPTION OF THE INVENTION

Hereinafter, a pitch pattern generation apparatus 1 according to an embodiment of the present invention will be explained with reference to the drawings.

### (1) CONFIGURATION OF THE PITCH PATTERN GENERATION APPARATUS

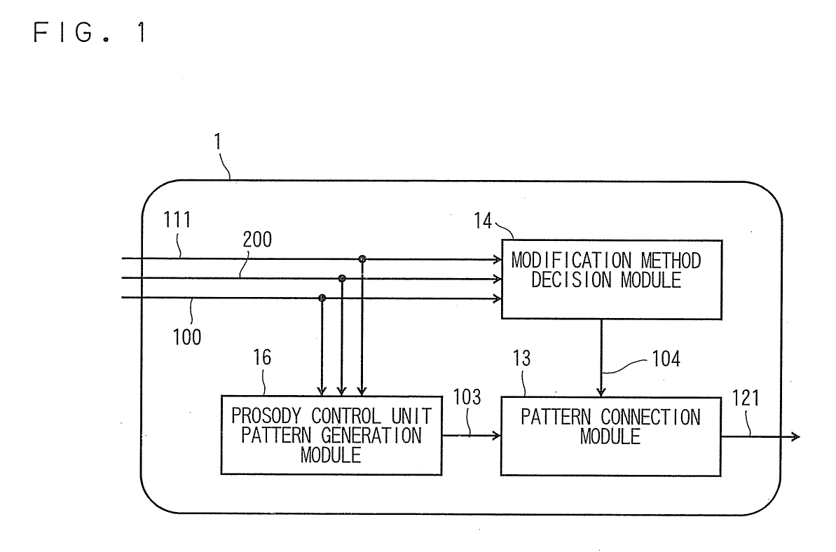

FIG. 1 shows a configuration example of a pitch pattern generation apparatus 1 according to the present embodiment.

The pitch pattern generation module 1 includes a prosody control unit pattern generation module 16, a modification method decision module 14 and a pattern connection module 13. In the following description, a case in which the prosody control unit is an accent phrase will be explained as an example.

A characteristic of the pitch pattern generation apparatus 1 according to the embodiment is a point in which modification such as smoothing processing is performed to the pitch pattern in the pattern connection module 13 in accordance with a modification method decided in the modification method decision module 14.

The functions of respective modules 13, 14 and 16 can be realized by describing as software and allowing a computer apparatus having appropriate components.

In addition, programs to be executed by the computer can be distributed by storing them in recording media such as a magnetic disk, an optical disk, and a semiconductor memory, or can be distributed through networks.

### (1-1) Prosody Control Unit Pattern Generation Module 16

The prosody control unit pattern generation module 16 generates pitch patterns 103 of each accent phrase based on language attribute information 100, phoneme duration 111 and emphasis degree information 200.

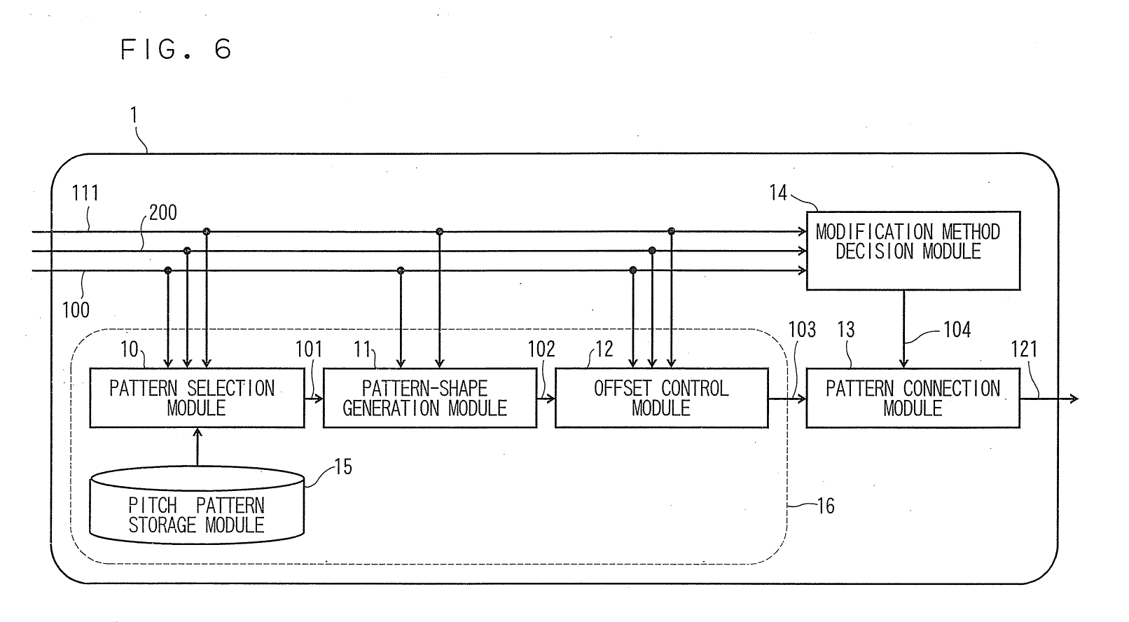

The prosody control unit pattern generation module 16 includes, for example, a pattern-shape selection module 10, a pattern-shape generation module 11, an offset control module 12 and a pitch pattern storage module 15 as shown in FIG. 6. “The language attribute information 100” is information which can be extracted from the input text by performing text analysis processing such as morphological analysis or syntactic analysis. For example, it is information concerning a phonological symbol string, a phonological type, a part of speech, an accent type, the number of syllables, the distance to the related word, pause, a position in a sentence and the like.

The following description will be made by taking a case as an example, in which “The emphasis degree information 200” is information indicating four-stages emphasis levels of output speech, namely, “emphasis 0 (no designation of emphasis), emphasis 1 (weak emphasis), emphasis 2 (moderate emphasis), emphasis 3 (strong emphasis)”. The pitch patterns 103 of each accent phrase are patterns reflecting the degree of emphasis.

### (1-2) Modification Method Decision Module 14

The modification method decision module 14 decides a modification method by the smoothing processing with respect to the pitch pattern 103 of each accent phrase in a connection portion between the accent phrase and at least one of adjacent accent phrases based on the language attribute information 100, the phoneme duration 111 and the emphasis degree information 200, and then outputs modification method information 104. The pitch pattern 103 of each accent phrase is generated by the above prosody control unit pattern generation module 16.

### (1-3) Pattern Connection Module 13

The pattern connection module 13 connects pitch patterns 103 of each accent phrase as well as performing processing such as smoothing processing in accordance with the modification method information 104 to prevent unnatural discontinuity at connection boundary portions, outputting a sentence pitch pattern 121.

### (2) PROCESSING IN THE PITCH PATTERN GENERATION APPARATUS 1

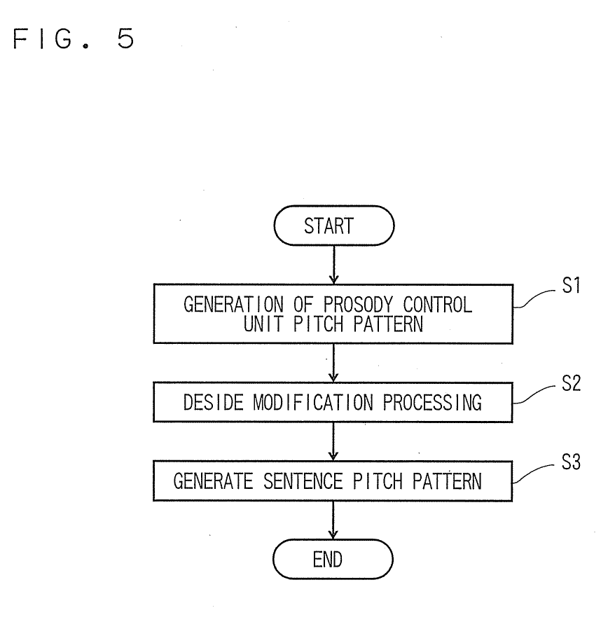

Next, respective processing of the pitch pattern generation apparatus 1 will be explained with reference to FIG. 5. FIG. 5 is a flowchart showing the flow of processing in the pitch pattern generation apparatus 1.

### (2-1) Step S1

First, in Step S1, the prosody control unit pattern generation module 16 generates pitch patterns 103 of each accent phrase based on the language attribute information 100, the phoneme duration 111 and the emphasis degree information 200.

### (2-1-1) Generation Method of Pitch Patterns 103

A generation method of pitch patterns 103 of each accent phrase having intonation variations according to the degree of emphasis will be explained with reference to FIG. 6.

For example, in the configuration as in FIG. 6, a pitch pattern is selected from the pitch pattern storage module 15 based on the language attribute information 100 and the emphasis degree information 200, and the selected pattern is expanded or contracted in the time axis direction in accordance with the phoneme duration 111 to generate the pattern shape, and further, an offset which is the height of the whole pattern is controlled based on the language attribute information 100 and the emphasis degree information 200, thereby generating the pitch pattern reflecting the degree of emphasis of each accent phase.

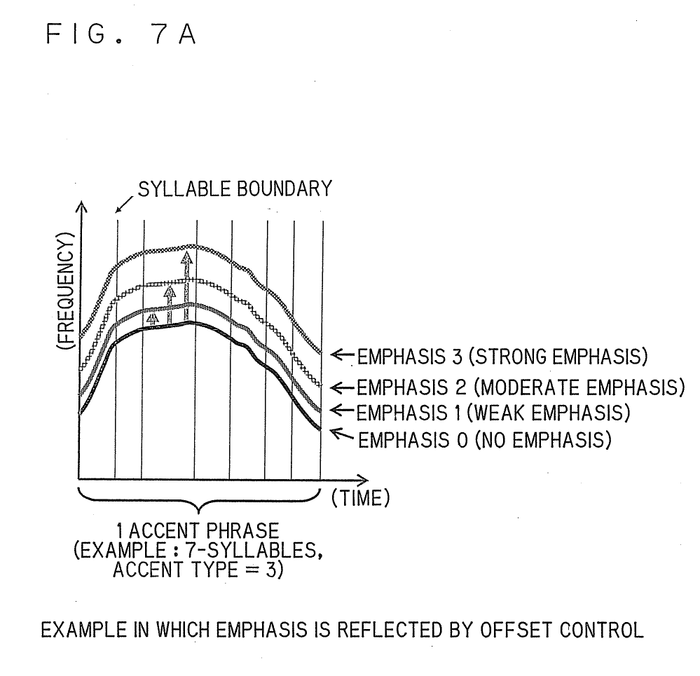

In FIG. 7A, an example of pitch patterns 103 reflecting the degree of emphasis are shown, which are generated by changing the offset of pitch patterns in accent phrase units according to the emphasis degree information 200.

It is not limited to the method or the configuration but there are a method of estimating control parameters of a functional approximation model based on the language attribute information 100, the emphasis degree information 200 and the like, and there are existing pitch pattern generation methods such as a method of generating a corpus base selecting a desired pattern from a pitch pattern of an original speech, or a point-pitch modeling. In FIG. 7B, an example of pitch patterns 103 reflecting the degree of emphasis is shown, which are generated by selecting desired pitch patterns in accent phrase units from the pitch pattern corpus according to the emphasis degree information 200.

### (2-1-2) Generated Pitch Patterns 103

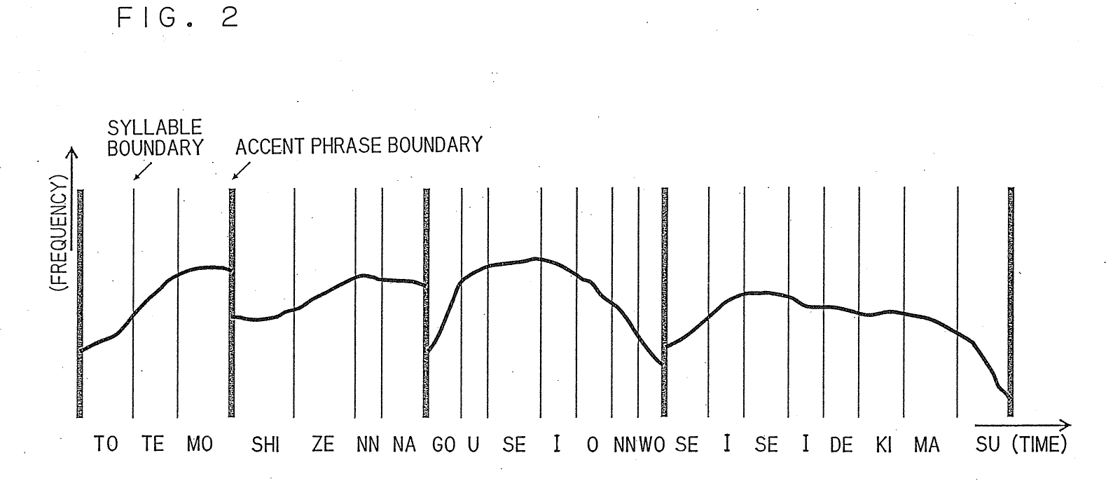

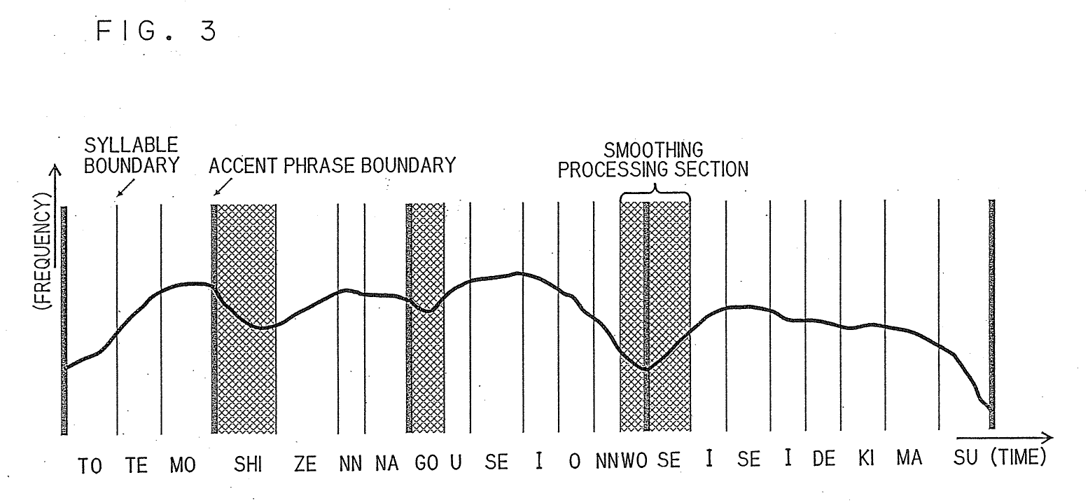

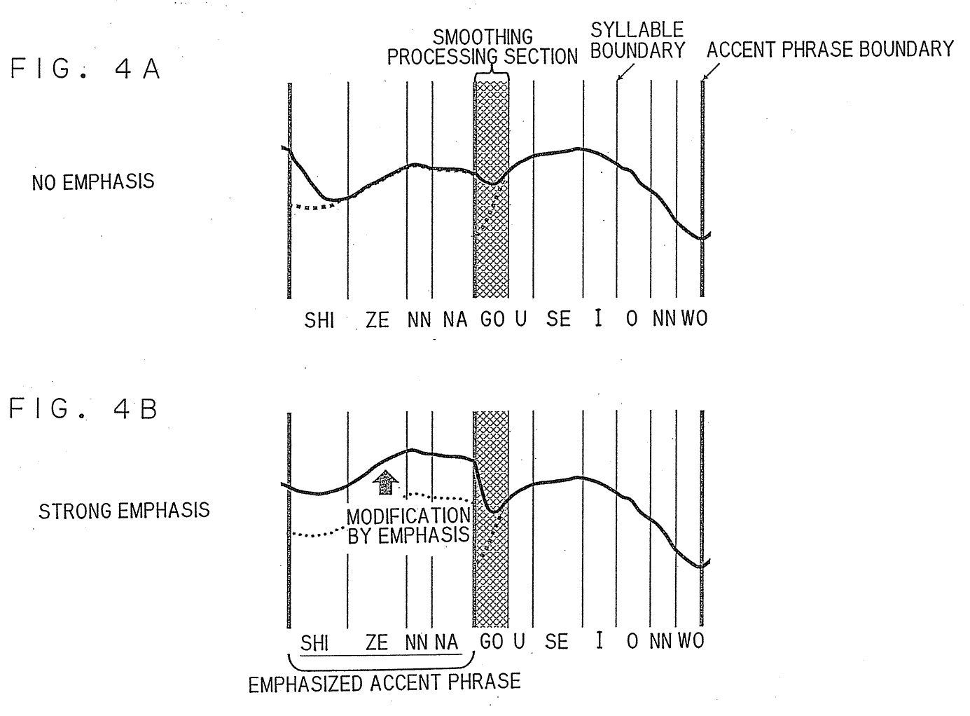

An example of pitch patterns 103 of each accent phrase generated with respect to the input text is shown in FIG. 2. As in the example, in the pitch patterns 103 of each accent phrase, pitches at boundary portions between adjacent accent phrases do not coincide in many cases.

As described above, pitch patterns 103 reflecting the degree of emphasis designated to the accent phrases are generated with respect to respective plural accent phrases corresponding to the input text are generated, then, the process proceeds to Step S2 of FIG. 5.

### (2-2) Step S2

In Step S2, the modification method decision module 14 decides a modification method by smoothing processing with respect to the pitch pattern 103 of each accent phrase in a connection portion between the accent phrase and at least one of the previous and next accent phrase based on the language attribute information 100, the phoneme duration 111 and the emphasis degree information 200, and then outputs modification method information 104.

The following description will be made by taking a case as an example, in which “The modification method information 104” is information of a target section for smoothing processing. That is, in order to decrease unnatural discontinuity of pitch changes at the connection portions between adjacent accent phrases, the modification method information 104 is information for the target section for the smoothing processing applied to pitch pattern 103 of each accent phrase in the pattern connection module 13.

In the following description, an example of the decision method in a smoothing processing section in the connection boundary portion between the accent phrase and a next accent phrase will be explained based on the emphasis degree information 200 and the information of accent type included in the language attribute information 100.

### (2-2-1) Emphasis 0, Emphasis 1

A case in which the emphasis degree information 200 is “Emphasis 0 (no emphasis)” or “Emphasis 1 (weak emphasis)” will be explained. In this case, the smoothing processing section in the connection portion between the accent phrase and the next accent phrase is considered to be divided into a flat type (the accent phrase without accented syllable) and not-flat type (the accent phrase with accented syllable).

In the case that the accent type of the accent phrase is the flat type, only the head syllable of the next accent phrase is regarded as a smoothing processing section.

In the case that the accent type of the accent phrase is not the flat type, the last syllable of the accent phrase and the head syllable of the next accent phrase are regarded as the smoothing processing section.

### (2-2-2) Emphasis 2

A case in which the degree of emphasis is “Emphasis 2 (moderate emphasis)” will be explained.

In the case that the accent type of the accent phrase is the flat type, a section from the head syllable to the half of the second syllable in the next accent phrase is regarded as the smoothing processing section.

In the case that the accent type of the accent phrase is not the flat type, a section from the last half of the syllable which is previous to the last syllable in the accent phrase to the half of the second syllable of the next accent phrase is regarded as the smoothing processing section.

### (2-2-3) Emphasis 3

The case in which the degree of emphasis is “Emphasis 3 (strong emphasis)” will be explained.

In the case that the accent type of the accent phrase is the flat type, a section from the head syllable to the second syllable of the next accent phrase is regarded as the smoothing processing section.

In the case that the accent type of the accent phrase is not the flat type, a section from the syllable which is previous to the last syllable of the accent phrase to the second syllable of the next accent phrase is regarded as the smoothing processing section.

### (2-2-4) Specific Example

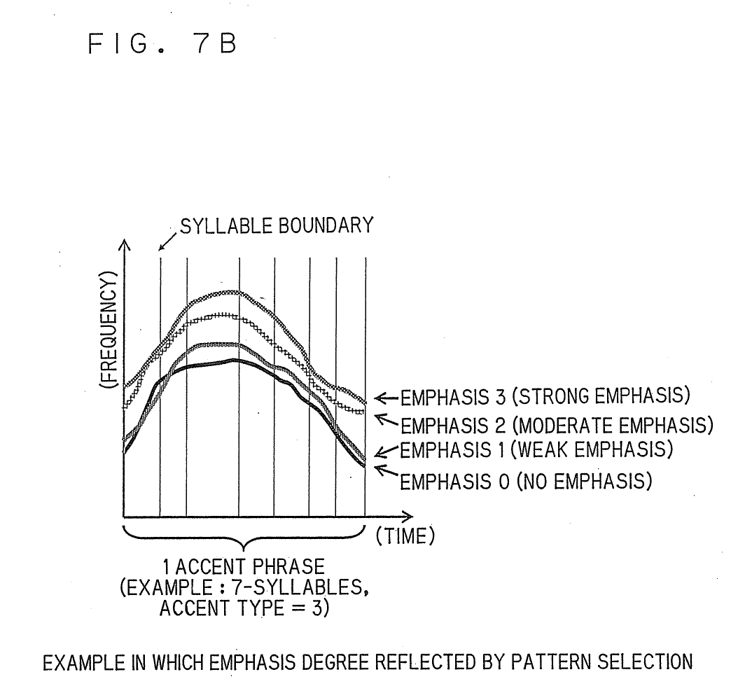

As shown in FIG. 8, for example, assume that the accent phrase is a flat-type accent phrase “shizenna” (meaning that “natural” in English). The next accent phrase is an accent phrase “gouseion-wo” (meaning that “synthetic speech is”).

In the case that the emphasis degree information 200 is “Emphasis 0 (no Emphasis)”, only the head syllable of the next accent phrase will be the smoothing processing section as shown in FIG. 8A. In the case of “Emphasis 3 (strong emphasis)”, a section to the second syllable of the next accent phrase will be the smoothing processing section as shown in FIG. 8B.

Accordingly, the modification method of the pitch pattern (in this case, the smoothing processing section) in the connection portion is controlled based on at least information of the degree of emphasis in each prosody control unit.

As described above, the modification method information 104 for the pitch patterns 103 of each accent phrase is generated with respect to respective plural accent phrases corresponding to the input text, then, the process proceeds to Step S3 in FIG. 5.

### (2-2-5) Modification Example

In the above description, the smoothing processing section is controlled in the unit of syllable, however, it is not limited to this.

For example, the unit may be the one which can represent the length of a processing section such as the unit of phonemes or the unit of seconds. In addition, the method of deciding the section may be the one which changes the length or the range (start point, end point) of the section according to at least emphasis degree information 200.

### (2-3) Step S3

In Step S3, the pattern connection module 13 modifies the pitch patterns 103 generated for each accent phrase by performing processing such as smoothing in accordance with the modification method information 104 so as to prevent discontinuity at connection boundary portions, as well as outputs a sentence pitch pattern 121 by connecting these pitch patterns 103.

Assume that a certain kind of smoothing method (smoothing function) is defined. A case in which the pitch pattern 103 of each accent phrase is modified with respect to the smoothing processing section of the modification method information 104 based on the smoothing function will be explained. That is, smoothing processing procedures in the boundary portion between the accent phrase and the next accent phrase will be explained.

### (2-3-1) First Procedure

First, in the case that the accent type of the accent phrase is the flat type, a pitch at the connection point between the accent phrase and the next accent phrase is a value of the end point of the accent phrase.

In the case that the accent type of the accent phrase is not the flat type, the pitch will be an average value of the pitch of the end point of the accent phrase and the pitch of the start point of the next accent phrase.

### (2-3-2) Second Procedure

The smoothing processing by a quadratic function is performed to the smoothing processing section designated as the modification method information 104 to modify respective pitch patterns. At this time, the modification is performed so that an end portion of the pitch pattern of the accent phrase is connected smoothly to the head portion of the pitch pattern of the next accent phrase.

### (2-3-3) Specific Example

For example, in the case that the accent phrase is the flat-type accent phrase “shizenna” (meaning that “natural”), a pitch value “pc” at the connection point (in this case, logarithmic fundamental frequency) will be the end point of the accent phrase, and a logarithmic fundamental frequency p (t) of time “t” in the pitch pattern of the next accent phrase is modified in the following manner.

$$p ( t ) = p ( t ) + \frac{{( l + t )}^{2}}{{l}^{2}} \times ( {p}_{c} - p ( 0 ) ) 0 \leq t \leq l - 1$$

In the above, “1” indicates the smoothing processing section length.

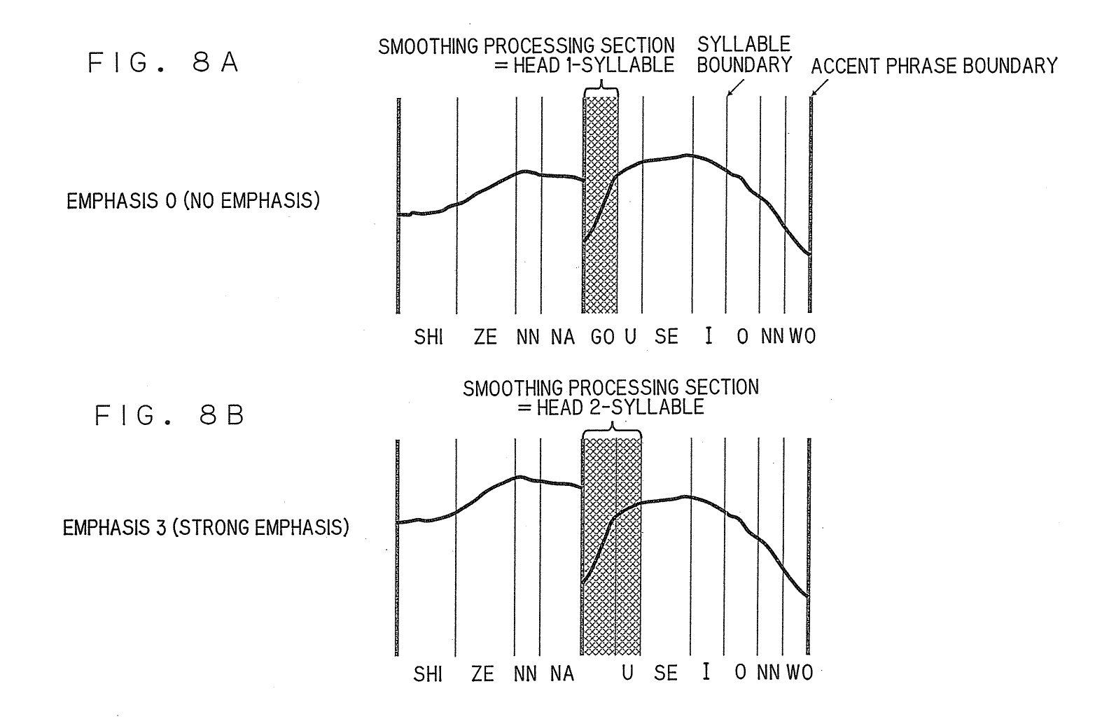

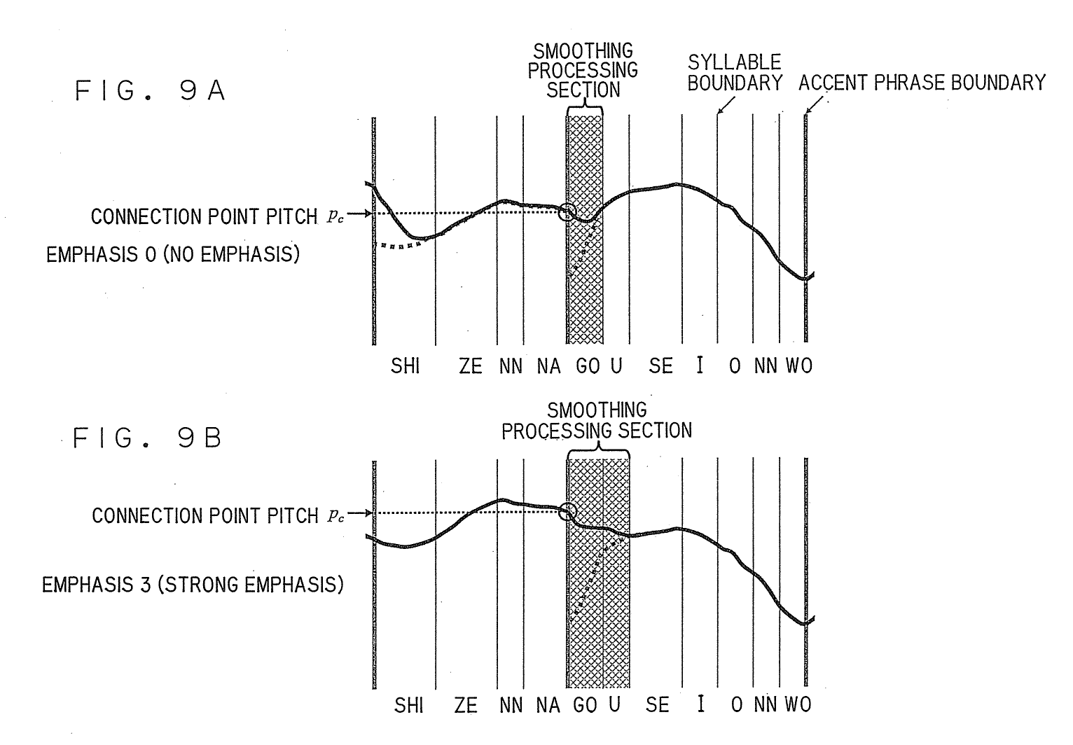

That is, as shown in FIG. 9A and FIG. 9B, the smoothing processing is applied in accordance with the smoothing processing section as modification method information decided in the modification method decision module 14 and pitch patterns are modified according to the degree of emphasis by the above smoothing function as in FIG. 9A and FIG. 9B, therefore, the pitch patterns having natural pitch changes are generated even at connection portions.

As described above, the pitch patterns 103 of each accent phrase are connected by performing modification based on the modification method information 104 to generate the pitch pattern 121 of the whole sentence which corresponds to the input text.

### (3) ADVANTAGES

As described above, according to the present embodiment of the invention, the following advantages can be obtained.

The modification method information 104 is outputted by deciding the modification method of pitch patterns in respective prosody control units at connection portions based on at least the emphasis degree information 200 in the modification method decision module 14. In addition, modification can be performed in the pattern connection module 13 based on the modification method information 104 in order to connect the pitch patterns 103 of each prosody control unit naturally and smoothly according to the emphasis degree.

### (4) COMPARISON TO RELATED ARTS

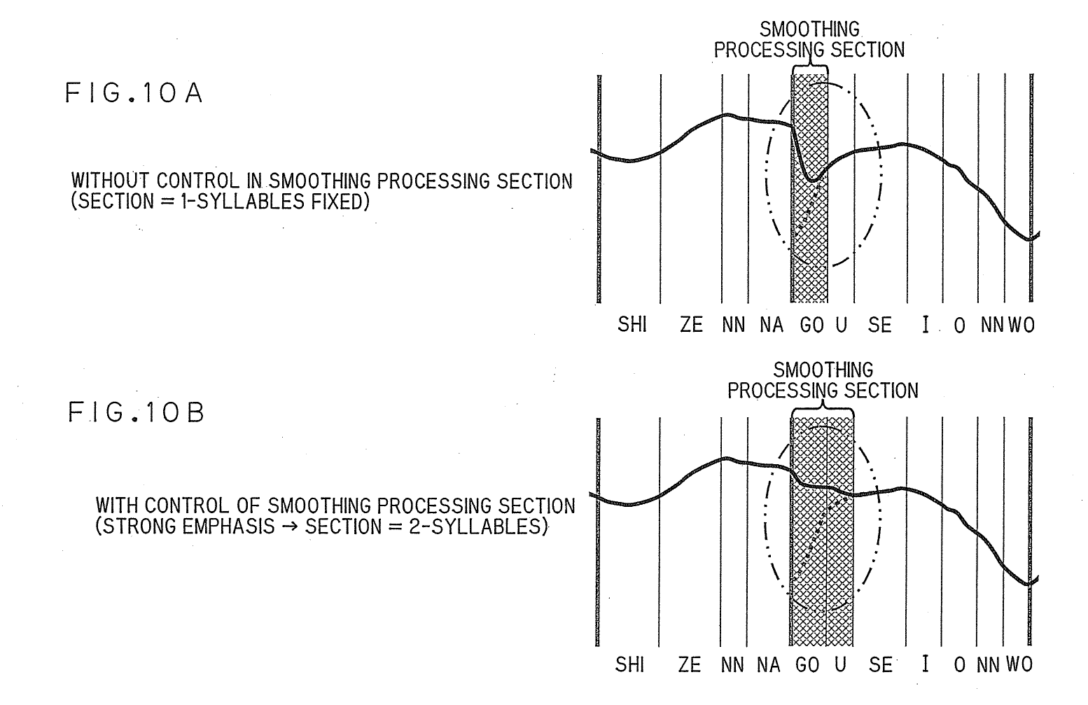

When the pitch patterns 103 of each prosody control unit are connected, the present embodiment shown in FIG. 10B is compared to a case in which modification is not performed based on the emphasis degree in the related art as shown in FIG. 10A (in the case referred to here, the smoothing processing section is fixed)

As shown in FIG. 10B, it is possible to perform the modification of the pitch pattern by the smoothing processing according to the degree of emphasis at the connection portion. Therefore, even when the degree of emphasis in the prosody control unit is strong and the pitch pattern 103 of the prosody control unit is largely changed, it is possible to decrease unnatural pitch change in the connection portion.

Also when the degree of emphasis is small, it is possible to prevent the emphasized part from being indistinct or being too flat by excessive smoothing because the modification method by the smoothing processing at the connection portion can be controlled.

As a result, it is possible to put proper stress and emphasis to intonation and to improve understandability or naturalness of the synthetic speech to be generated.

### (5) MODIFICATION EXAMPLES

The present invention is not limited to the above embodiment as they are but can be embodied by modifying components in a range not departing from the gist thereof when being put into practice.

In addition, various inventions can be formed by proper combinations of plural components disclosed in the above embodiment. For example, it is possible to cut some of components from all components shown in the embodiment. It is also preferable to combine components in different embodiments appropriately.

Hereinafter, the modification examples will be explained in order.

### (5-1) Modification Example 1

In the above embodiment, the modification method decision module 14 decides the smoothing processing section which is the target section for the smoothing processing applied by the pattern connection module 13 as the modification method information 104, however, it is not limited to this.

That is, it is preferable that the modification method decision module 14 decides information which can expressing the modification method for connecting the pitch patterns 103 of each prosody control unit naturally in the pattern connection module 13.

For example, it is preferable to prepare one or more smoothing methods (smoothing functions) in the pattern connection module 13 to decide the smoothing method to be applied to the pitch pattern 103 of each prosody control unit and the smoothing processing section to which the smoothing method is applied based on at least the emphasis degree information 200.

Specifically, in the pattern connection module 13, in addition to the above method using the quadratic function, a smoothing function for modifying the pattern strongly at the first half of the smoothing processing section and a smoothing function for modifying the pattern strongly at the last half of the smoothing processing section are prepared as the smoothing method. Then, the modification method decision module 14 decides information for selecting one of the three kinds of smoothing functions and the target section for the smoothing processing using the selected smoothing function as the modification method information 104 based on the emphasis degree information 200 and the language attribute information 100.

### (5-2) Modification Example 2

It is preferable to hold a smoothing pattern, not the smoothing function as the smoothing method. In the modification example 1, it is also preferable that plural smoothing patterns are prepared and information for selecting the patterns is decided as the modification method information 104.

### (5-3) Modification Example 3

It is also preferable that the modification method is decided by deciding the pitch of the connection point at the connection boundary which is used in the pattern connection module 13 based on at least the emphasis degree information 200.

Specifically, when the accent type of the accent phrase is the flat-type, a connection-point pitch at the connection boundary between the accent phrase and the next accent phrase is decided to be a value at the end point of the accent phrase.

When the accent type of the accent phrase is not the flat type, the pitch is decided according to the following conditions.

The first condition is when the emphasis degree is stronger than the emphasis degree of the next accent phrase. At this time, the connection-point pitch is decided to be a value higher than an average value of the pitch of the end point in the accent phrase and the pitch of the start point in the next accent phrase.

The second condition is when the emphasis degree is equal. At this time, the average value of the above pitches is decided.

The third condition is when the emphasis degree of the accent phrase is weaker than the emphases degree of the next accent phrase. At this time, a value lower than the average value is decided.

As described above, the modification method of the pitch pattern at the connection point can be controlled also by changing the pitch at the connection point according to the emphasis degree.

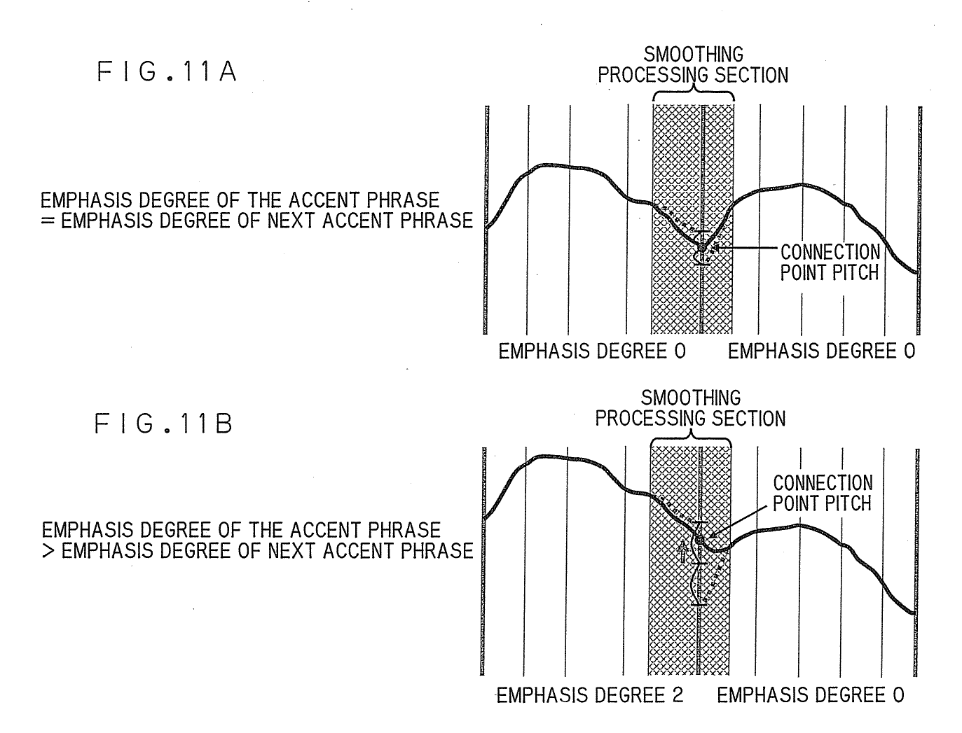

An example of changing the method of deciding the boundary point according to the emphasis degree is shown in FIG. 11A and FIG. 11B. Since both the accent phrase and the next accent phrase are not emphasized (emphasis degree 0) in FIG. 11A, the second condition is applied, and the connection pitch is decided to be the average value of the end-point pitch of the accent phrase and the start-point pitch of the next accent pitch. On the other hand, since the accent phrase is emphasized in FIG. 11B, the first condition is applied and the connection pitch is decided to be the value higher than the average value, thereby connecting the emphasized accent phrase and the not-emphasized next accent phrase smoothly without unnatural pitch change at the connection portion.

### (5-4) Modification 4

In the above embodiment, the modification method decision module 14 decides the modification method of the pitch patterns based on the emphasis degree information 200 with respect to the prosody control unit and information of the accent type included in the language attribute information 100, however, it is not limited to this.

For example, it is also preferable that modification method is decided by using information of the difference between the emphasis degree of the prosody control unit and the emphasis degree of the previous and next prosody control units.

In addition to the information indicating the emphasis degree, information such as the phoneme duration 111 near the connection boundary, the number of syllables included in the language attribute information 100 and phoneme types can be used, thereby controlling the modification method more precisely and performing suitable modification with respect to the various types of pitch-pattern connections in the pattern connection module 13.

### (5-5) Modification Example 5

In the above embodiment, the pattern connection module 13 performs the modification by the smoothing processing with respect to the pitch patterns 103 in the prosody control units, then, connects the modified pitch patterns to generate the pitch pattern 121 of the whole sentence, however, the processing procedure is not limited to this.

For example, it is possible that the pitch patterns 103 of each prosody control unit are connected in advance and after that, the modification by the smoothing processing is performed to the connection portions based on the modification method information 104.

### (5-6) Modification Example 6

In the above embodiment, the emphasis degree information 200 is the information expressing four-stages emphasis levels of output speech, however, it is not limited to this.

For example, in the case that tag information for designating stress variations of output speech or the range thereof is added to the input text, the emphasis degree information 200 can be generated from the emphasis degree included in the tag information. It is also possible to use tag information for designating emotion expression as long as the information which can be converted to the designation of the changing degree of prosody.

As specific examples for tag information, there are SSML (Speech Synthesis Markup Language) which is the description language for using the speech synthesis function on Web pages or JEIDA-62-2000 which is a standard of symbols for Japanese text speech synthesis and the like.

As another example of the emphasis degree information 200, it is possible to use information concerning stress variations of output speech estimated or extracted by performing text analysis processing and the like with respect to the input text.

It is also possible to use the degree (variation amount) in which the pitch pattern generated in the prosody control unit pattern generation module 16 changes according to the emphasis existence as new information for emphasis degree.

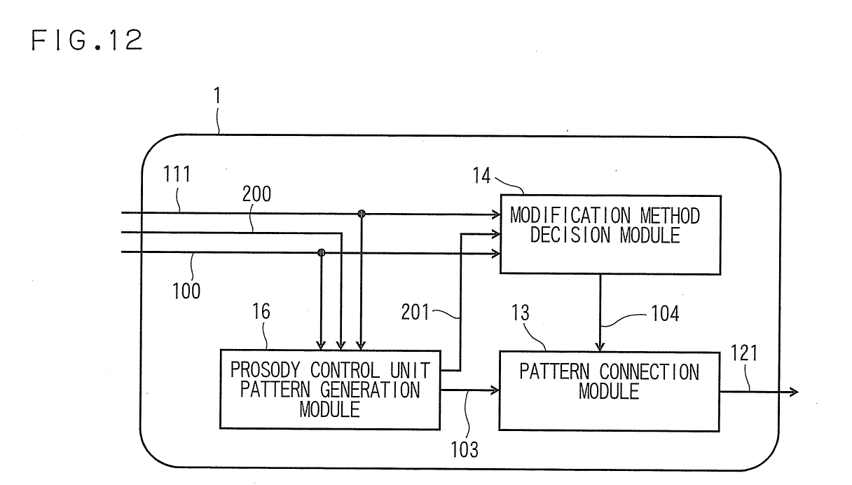

In this case, the configuration will be, for example, as shown in FIG. 12. In addition to the pitch patterns 103 generated in accordance with the emphasis degree information 200, the prosody control unit pattern generation module 16 calculates variation amounts (for example, the difference of average pitches or the difference of start point and end point pitches and the like) from pitch patterns generated as patterns to which emphasis is not particularly designated (default degree of emphasis), and then outputs them to the modification method decision module 14 as information indicating the new degree of emphasis (new emphasis degree information 201).

What is claimed is:

1. A pitch pattern generation method which connects pitch patterns in respective prosody control units in a text to be a target for speech synthesis to generate a pitch pattern corresponding to the text, comprising:
a first generating step of generating first pitch pattern reflecting an emphasis degree with respect to respective prosody control unit in the text based on emphasis degree information indicating the emphasis degree in the respective prosody control units and language attribute information in speech to be synthesized;
a method deciding step of deciding at least (1) a parameter relating to given smoothing processing or (2) a modification method at a connection portion relating to given smoothing processing, for smoothing connection portions in at least one of previous and next connection portions between the respective first pitch patterns and other first pitch patterns based on the emphasis degree information; and
a second generating step of modifying the connection portions of the first pitch patterns based on the modification method to generate a second pitch pattern corresponding to the text.

2. The method according to claim 1,
wherein, in the method deciding step, a smoothing section which is a section to which the smoothing processing is applied in the connection portion is decided based on the emphasis degree information.

3. The method according to claim 1,
wherein, in the method deciding step,
one smoothing function is selected as the modification method from plural smoothing functions stored in advance based on the emphasis degree information, and
a smoothing section in the connection portion to which the selected one smoothing function is applied is decided based on the emphasis degree information.

4. The method according to claim 1,
wherein, in the method deciding step,
a pitch of a connection point at a boundary between the first pitch patterns is decided based on the emphasis degree information, and
the modification method in the connection portion of the first pitch patterns is decided so that the connection point will be a position of the pitch.

5. The method according to claim 1,
wherein, in the method deciding step,
at least one of the language attribute information of the accent type, the number of syllables and the phoneme type in each prosody control unit is referred in addition to the emphasis degree information.

6. The method according to claim 1,
wherein, in the method deciding step,
the modification method is decided so that the larger the emphasis degree of the emphasis degree information is, the larger the modification amount with respect to the connection portion of the first pitch patterns becomes.

7. The method according to claim 1,
wherein, in the method deciding step,
the modification method is decided so that the larger the difference between the emphasis degree of the first pitch pattern and the emphasis degree of the other first pitch patterns which are previous and next to the first pitch pattern is, the larger the modification amount with respect to the connection portion of the first pitch patterns becomes.

8. The method according to claim 1,
wherein the emphasis degree information is an emphasis degree in each prosody control unit designated from the outside.

9. The method according to claim 1,
wherein the emphasis degree information is an emphasis degree estimated in each prosody control unit based on the text.

10. The method according to claim 1,
wherein the emphasis degree information is an emphasis degree based on the variation amount of the first pitch pattern according to existence of emphasis.

11. A pitch pattern generation apparatus which connects pitch patterns in respective prosody control units in a text to be a target for speech synthesis to generate a pitch pattern corresponding to the text, comprising:
a first generation module configured to generate first pitch pattern reflecting an emphasis degree with respect to respective prosody control unit in the text based on emphasis degree information indicating the emphasis degree in the respective prosody control units and language attribute information in speech to be synthesized;
a method deciding module configured to decide at least (1) a parameter relating to given smoothing processing or (2) a modification method at a connection portion relating to given smoothing processing, for smoothing connection portions in at least one of previous and next connection portions between the respective first pitch patterns and other first pitch patterns based on the emphasis degree information; and
a second generation module configured to modify the connection portions of the first pitch patterns based on the modification method to generate a second pitch pattern corresponding to the text.

12. The apparatus according to claim 11,
wherein the method deciding module decides a smoothing section which is a section to which the smoothing processing is applied in the connection portion based on the emphasis degree information.

13. The apparatus according to claim 11,
wherein the method deciding module selects one smoothing function as the modification method from plural smoothing functions stored in advance based on the emphasis degree information, and decides a smoothing section in the connection portion to which the selected one smoothing function is applied based on the emphasis degree information.

14. The apparatus according to claim 11,
wherein the method deciding module decides a pitch of a connection point at a boundary between the first pitch patterns based on the emphasis degree information, and decides the modification method in the connection portion of the first pitch patterns so that the connection point will be a position of the pitch.

15. Recording media storing a pitch pattern generation program which connects pitch patterns in respective prosody control units in a text to be a target for speech synthesis to generate a pitch pattern corresponding to the text, realizing the following functions by a computer:
a first generation function of generating first pitch pattern reflecting an emphasis degree with respect to respective prosody control unit in the text based on emphasis degree information indicating the emphasis degree in the respective prosody control units and language attribute information in speech to be synthesized;
a method deciding function of deciding at least (1) a parameter relating to given smoothing processing or (2) a modification method at a connection portion relating to given smoothing processing, for smoothing connection portions in at least one of previous and next connection portions between the respective first pitch patterns and other first pitch patterns based on the emphasis degree information; and
a second generation function of modifying the connection portions of the first pitch patterns based on the modification method to generate a second pitch pattern corresponding to the text.

16. The recording media according to claim 15,
wherein the method deciding function decides a smoothing section which is a section to which the smoothing processing is applied in the connection portion based on the emphasis degree information.

17. The recording media according to claim 15,
wherein the method deciding function selects one smoothing function as the modification method from plural smoothing functions stored in advance based on the emphasis degree information, and decides a smoothing section in the connection portion to which the selected one smoothing function is applied based on the emphasis degree information.

18. The recording media according to claim 15,
wherein the method deciding function decides a pitch of a connection point at a boundary between the first pitch patterns based on the emphasis degree information, and decides the modification method in the connection portion of the first pitch patterns so that the connection point will be a position of the pitch.
